(19) United States
(12) Patent Application Publication
(10) Pub. No.: US 2024/0258522 A1
(43) Pub. Date: Aug. 1, 2024

(54) HYBRID CATHODE FOR BATTERIES AND RELATED METHODS

(71) Applicants: Peter Malati, Hawthorne, CA (US); Max Tsao, Springboro, OH (US); Tadej Semenic, Thousand Oaks, CA (US)

(72) Inventors: Peter Malati, Hawthorne, CA (US); Max Tsao, Springboro, OH (US); Tadej Semenic, Thousand Oaks, CA (US)

(21) Appl. No.: 18/424,363

(22) Filed: Jan. 26, 2024

Related U.S. Application Data
(60) Provisional application No. 63/481,765, filed on Jan. 26, 2023.

(51) Int. Cl. H01M 4/587; H01M 4/02; H01M 4/04; H01M 4/08; H01M 4/38; H01M 4/50; H01M 4/60; H01M 4/62; H01M 4/70; H01M 6/02

(52) U.S. Cl. CPC H01M 4/587; H01M 4/0492; H01M 4/08; H01M 4/382; H01M 4/50; H01M 4/60; H01M 4/622; H01M 4/625; H01M 4/70; H01M 6/02; H01M 2004/021; H01M 2004/027; H01M 2004/028

(57) ABSTRACT

Techniques are provided for implementing hybrid cathodes for batteries. In one example, a battery cathode includes a solid cathode material having an open pore structure and formed of a carbon monofluoride material and one or both of a phthalocyanine compound and a manganese oxide material and lithium polysulfide disposed within pores of the solid cathode material. In another example, a method includes assembling a solid cathode material and lithium metal anode with a porous separator therebetween, where the solid cathode material has an open pore structure and is formed of a carbon monofluoride material and one or both of a phthalocyanine compound and a manganese oxide, forming a catholyte having lithium polysulfide and infiltrating pores of the solid cathode material and the separator with the catholyte.

### CROSS REFERENCE TO RELATED APPLICATIONS

This application claims priority to and the benefit of U.S. Provisional Patent Application No. 63/481,765 filed Jan. 26, 2023 and entitled “HYBRID CATHODE FOR BATTERIES AND RELATED METHODS” which is incorporated herein by reference in its entirety.

### TECHNICAL FIELD

The present disclosure relates generally to hybrid cathodes for batteries and batteries including the same.

### BACKGROUND

Many applications, such as unmanned vehicles, robots, and consumer electronics rely heavily on battery power and there is a need for high performance primary batteries. For example, certain unmanned aerial vehicles (UAVs) may require both high power density (about 1250 W/kg) for vertical takeoff and/or landing and high energy density (about 750 Wh/kg) to endure long flight times under normal operating loads. Lithium metal batteries are considered to be among the most energy-dense batteries, which makes them a suitable power source for such applications. Increasing energy density is key in battery-dependent applications where even a slight reduction in weight can yield massive improvement in performance. However, existing batteries are limited in power and energy density due to inactive material mass, such as that of the current collectors, separator, electrolyte, cathode void volume, and battery housing and packaging.

In particular, one reason lithium metal batteries may be lacking in gravimetric and volumetric energy density is the presence of dead (i.e., inactive) mass and dead volume, respectively, occupied by the electrolyte because electrolytes do not contain any discharge energy. As such, when the electrolyte penetrates pores in the cathode and separator, it increases the overall mass of the battery but it does not add any chemical energy to the battery. Batteries need to accommodate more chemical energy in order to provide discharge energy.

### SUMMARY

Various techniques are disclosed to provide a hybrid cathode and a battery including the same for use in applications such as unmanned vehicles, robots (e.g., those used in aerospace and deep space industries), and consumer electronics. The hybrid cathode described herein may increase energy and power density by incorporating active material into void spaces of the cathode leading to significant improvements in energy density without hindering discharge kinetics.

In one embodiment, a hybrid cathode includes a solid cathode material having an open pore structure and formed of a carbon monofluoride material and one or both of a phthalocyanine compound and a manganese oxide material and lithium polysulfide disposed within pores of the solid cathode material.

In another embodiment, a battery includes a cathode having a solid cathode material with an open pore structure and formed of a carbon monofluoride material and one or both of a phthalocyanine compound and a manganese oxide material, a porous separator, a lithium metal anode, and a catholyte including lithium polysulfide. The catholyte is disposed within pores of the solid cathode material and of the separator.

In another embodiment, a method includes assembling a solid cathode material and lithium metal anode with a porous separator therebetween, the solid cathode material having an open pore structure and being formed of a carbon monofluoride material and one or both of a phthalocyanine compound and a manganese oxide material, forming a catholyte including lithium polysulfide, and infiltrating pores of the solid cathode material and the separator with the catholyte.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an exploded diagrammatic view of a battery in accordance with embodiments of the disclosure.

FIG. 2 illustrates a diagrammatic view of a battery in accordance with embodiments of the disclosure.

FIG. 3 illustrates a process of forming a hybrid cathode in accordance with embodiments of the disclosure.

FIG. 4 illustrates a process of forming a battery in accordance with embodiments of the disclosure.

FIG. 5 illustrates discharge results for an example battery in accordance with embodiments of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

In one or more embodiments, a hybrid cathode is provided having a liquid active material infiltrated into pores of the solid cathode material. In particular, the solid cathode material is formed of a carbon monofluoride material and one or both of a phthalocyanine compound and a manganese oxide material and includes open pores that are permeable to liquid. Liquid lithium polysulfide is infiltrated into the pores of the solid cathode material, thereby increasing the chemical energy of the hybrid cathode without increasing a volume thereof. The lithium polysulfide is contained in a catholyte including an electrolyte having the lithium polysulfide dissolved therein. Also provided herein is a battery including the hybrid cathode and a porous separator. The catholyte likewise infiltrates pores of the separator, thereby further increasing the available chemical energy in the battery.

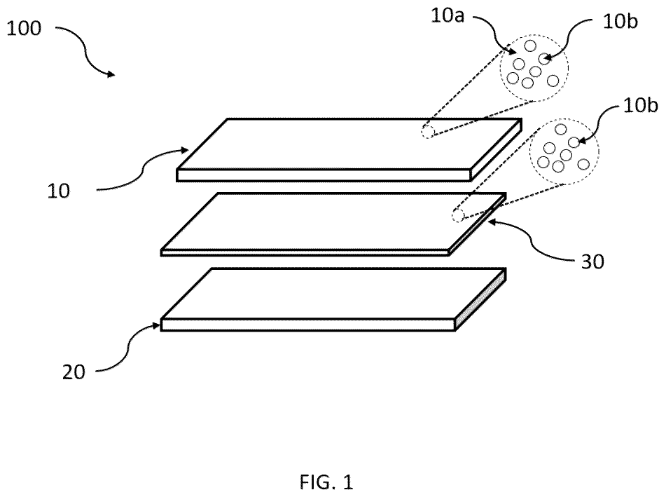

Turning to FIG. 1, a battery 100 according to embodiments of the present disclosure is depicted. In some embodiments, the battery 100 is a lithium metal battery such as a button or coin cell battery, a prismatic cell battery, a pouch cell battery, or a cylindrical cell battery. In some embodiments, the battery 100 is a primary battery.

The battery 100 includes a hybrid cathode 10. The hybrid cathode 10 includes a solid cathode material 10a, which includes pores that are liquid permeable. The solid cathode material 10a is formed of carbon monofluoride material and one or both of a phthalocyanine compound and a manganese oxide material. The carbon monofluoride material may be represented by the formula CFₓ, wherein x is about 0.5 to 1.2. In some embodiments, x may be about 0.5 to about 0.9, greater than 0.5 to 0.95, 0.6 to 1.2, or 0.5 to 1.1. The phthalocyanine compound may be represented by the formula MPc, where M is a metal. In some embodiments, M is Cu, Fe, Co, Zn, Sn, Pb, Ni, Mg, Mn, Cd, Ag, FCr, Li₂, or VO. In some embodiments, M is Cu. In some embodiments, the manganese oxide material is represented by the formula MnO₂. In some embodiments, a molar ratio of the carbon monofluoride material (CFₓ) to the phthalocyanine compound (MPc) is 100:0 to 20:80, 90:1 to 1:3, 50:1 to 1:1, or 40:1 to 2:1. In some embodiments, a molar ratio of CFₓ:MnO₂ is 100:0 to 10:90, 50:1 to 1:4, or 10:1 to 1:5. In some embodiments, the solid cathode material 10a comprise CFₓ and both MPc and MnO₂.

In addition to the carbon monofluoride material, the phthalocyanine compound, and/or the manganese oxide material, the solid cathode material 10a may include additives and/or binders. In some embodiments, the solid cathode material 10a includes a conductive additive. In some embodiments, the conductive additive is carbon black, acetylene black, carbon nanotubes, graphene, or combinations thereof. In some embodiments, the conductive additive is present in an amount, based on the total weight of the solid cathode material 10a, of greater than 0 to 75 wt %, 5 to 50 wt %, 10 to 40 wt %, or 20 to 40 wt %.

In some embodiments, the solid cathode material 10a include a polymer binder. In some embodiments, the polymer binder is a fluorinated alkane polymer, an alkane polymer, a hydroxyl-functionalized alkane polymer, an amide-functionalized alkane polymer, a nitrile-functionalized alkane polymer, an amine polymer, an aromatic-functionalized alkane polymer, an aromatic polymer, a saccharide polymer, a thiophene polymer, a polyether polymer, or combinations thereof. In some embodiments, the polymer binder is present in an amount, based on the total weight of the solid cathode material 10a, of greater than 0 to 20 wt %, 1 to 15 wt %, 2 to 10 wt %, about 1 wt %, about 2 wt %, about 5 wt %, or about 7 wt %.

The solid cathode material 10a has a porosity greater than 0% and at least a portion of the pore volume of the solid cathode material 10a is accessible to be occupied by a catholyte 10b. In some embodiments, the solid cathode material 10a has a porosity of at least 1%, at least 5%, at least 10%, greater than 0 to 80%, 1 to 70%, 5 to 60%, or 10 to 50%. In some embodiments, at least 80%, at least 85%, at least 90%, at least 95%, at least 99%, or about 100% of the pore volume of the solid cathode material 10a is filled with the catholyte 10b.

The catholyte 10b includes lithium polysulfide. In some embodiments, the lithium polysulfide is represented by the formula Li₂S_{y} where y is 3 to 12, 4 to 12, 3 to 8, 6 to 12, at least 3, greater than 3, at least 4, greater than 4, at least 5, or at least 6. In the catholyte 10b, the lithium polysulfide is dissolved in an electrolyte. In some embodiments, a concentration of the lithium polysulfide in the catholyte 10b is 0.1 to 4M, 0.5 to 3M, 1 to 2M, 0.1 to 1M, 0.1 to 2M, 1 to 2M, or 0.5 to 1.5M.

The electrolyte includes a solvent and may include one or more salts dissolved therein in addition to the lithium polysulfide. In some embodiments, solvents and salts known in the field of lithium primary batteries may be used. In some embodiments, the electrolyte is a nonaqueous electrolyte. In some embodiments, the solvent is an amide, a cyclic or noncyclic acetal, dimethyl ethers of ethylene glycol such as dimethoxyethane (DME or glyme), diglyme, triglyme, tetraglyme (TG), and the like, dimethyl sulfoxide (DMSO), tetrahydrofuran, dioxolane, dimethylformamide, acetonitrile, sulfolane, derivatives thereof, or combinations thereof. In some embodiments, the salt is lithium hexafluorophosphate (LiPF₆), lithium bis(fluorosulfonyl)imide (LiFSI), lithium (fluorosulfonyl)(trifluoromethanesulfonyl) imide (LiFTFSI), lithium bis(trifluoromethylsulfonyl)imide (LiTFSI), lithium trifluoromethanesulfonate (Li triflate), lithium nitrate, or combinations thereof. In some embodiments, a concentration of the salt (other than lithium polysulfide) in the catholyte 10b is 0.1 to 4M, 0.1 to 3M, 0.1 to 2M, 1 to 2M, 0.3 to 1.5M, or 0.5 to 1M.

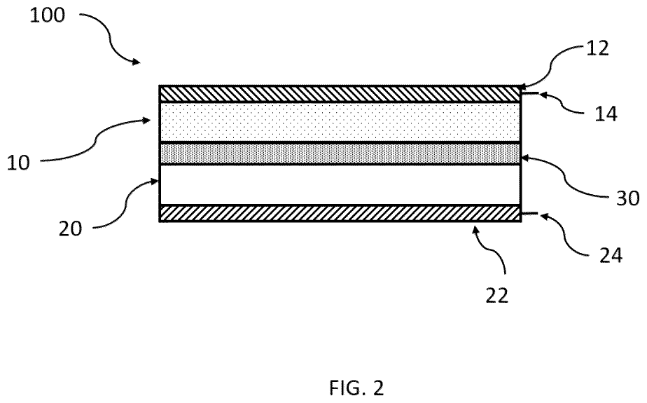

The hybrid cathode 10 includes a cathode current collector 12 affixed to a surface thereof, such as the cathode current collector 12 shown in FIG. 2. The cathode current collector 12 may be formed of materials including, but not limited to, nickel, steel, aluminum, titanium, platinum, copper, gold, or combinations thereof. A cathode terminal 10c may be connected to cathode current collector 12 for connecting a load to the battery 100.

The battery 100 further includes an anode 20. In some embodiments, the anode 20 is a solid, non-porous metal anode. In some embodiments, the anode 20 is formed of lithium. In some embodiments, the anode 20 is formed of silicon or carbon. The anode 20 includes an anode current collector 22, such as that shown in FIG. 2. The anode current collector 22 may be formed of materials including, but not limited to, nickel, steel, aluminum, titanium, platinum, copper, gold, or combinations thereof. An anode terminal 24 may be connected to anode current collector 22 for connecting a load to the battery 100.

The battery 100 further includes a porous separator 30. The separator 30 facilitates ion transfer from the anode 20 to the hybrid cathode 10 during discharge while isolating these components to avoid a short circuit. In some embodiments, the separator 30 has a porosity of at least 20%, at least 30%, at least 40%, at least 50%, at least 60%, at least 70%, at least 80%, 20% to 80%, 30% to 70%, about 40%, or about 50%. The composition of the separator 30 is not particularly limited in the battery 100. Suitable separators 30 include any porous membrane having resistance to the internal environment of a primary lithium battery. For example, a nonwoven material formed from polymers such as polyethylene, polypropylene, and polyethylene terephthalate, ceramics materials such as glass fibers, cellophane, nylon, or combinations thereof may be used as the separator 30. In the embodiment shown in FIG. 1, the separator 30 includes the catholyte 10b disposed within its pores. In some embodiments, at least 80%, at least 90%, at least 95%, or about 100% of the pore volume of the separator 30 is filled with the catholyte 10b.

As assembled, the catholyte 10b resides within voids of the porous solid cathode material 10a. When an external load is applied, the carbon monofluoride material, phthalocyanine compound, and/or manganese oxide material form inorganic and organic lithium compounds and/or lithium intercalated species in the solid cathode material 10a and the lithium polysulfide forms lithium sulfides at the cathode surface. The CFₓ-MPc-MnO₂—Li₂S_{y} hybrid cathode 10 synergistically discharges to produce reduced lithium compounds and electricity. Without being bound by theory, it is understood that the MPc enhances reduction of CFₓ and simultaneously attracts Li₂S_{y} to the reduction site before it is reduced itself, while MnO₂ provides additional discharge energy and simultaneously attracts Li₂S_{y} to the reduction site. An increase in discharge energy is observed in the battery 100 due to the additional chemical energy from the lithium polysulfide bonds in the voids of the solid cathode material 10a. In some embodiments, discharge of the Li₂S_{y} within pores of the solid cathode material 10a may occur at 1 to 3 V, 1.5 to 2.8 V, or 1.8 to 2.4 V.

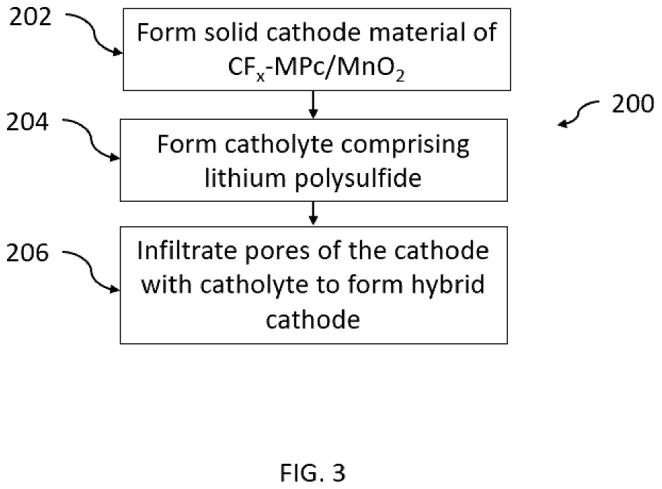

Turning to FIG. 3, a method 200 of forming the hybrid cathode 10 is shown. Method 200 includes various steps (e.g., also referred to as blocks or operations) further discussed below. In a step 202, the solid cathode material 10a is formed from the carbon monofluoride material and one or both of the phthalocyanine compound and the manganese oxide material. In step 202, the carbon monofluoride material, the phthalocyanine compound, and/or the manganese oxide material may be mixed with one or more additives and/or binders, such as those described above. These components may be further mixed with a solvent, such as N-methyl-2-pyrrolidone (NMP) and/or dimethylformamide (DMF), to form a slurry or paste. The slurry or paste is deposited onto a surface, such as a foil current collector. The solvent is then evaporated from the slurry or paste to form the solid cathode material 10a.

In a step 204, the catholyte 10b is formed. Step 204 may be performed simultaneously with step 202, before step 202, or after step 202. To form the catholyte 10b, a lithium sulfide precursor is reacted with sulfur in a solvent, such as those described above, to form lithium polysulfide represented by the formula Li₂S_{y} where y is in a range of 3 to 12. The electrolyte salt is then dissolved in the lithium polysulfide solution to form the catholyte 10b. The electrolyte composition and lithium polysulfide concentration may be as described above.

Next, in step 206, the catholyte 10b is infiltrated into pores of the solid cathode material 10a to form the hybrid cathode 10. In some embodiments, step 206 includes placing the solid cathode material 10a in a container (such as a battery housing) and then injecting the catholyte 10b into the container (the order of these operations may be reversed). In some embodiments, the infiltration may be passive. That is, the catholyte 10b may be drawn into the solid cathode material 10a by capillary forces. In some embodiments, the infiltration may be assisted by use of vacuum. In some embodiments, the infiltration step 206 may last for 1 to 48 hours, 2 to 24 hours, or 6 to 24 hours, or 12 to 24 hours.

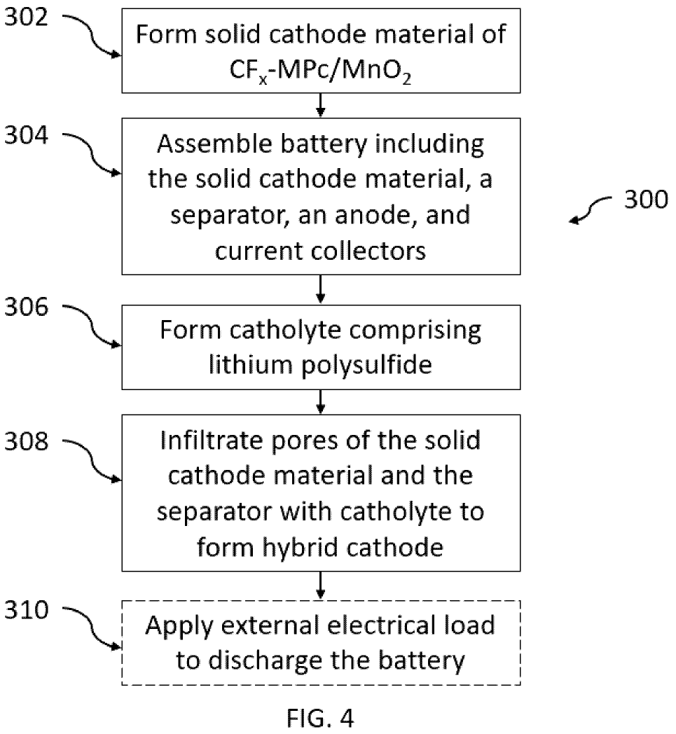

Turning to FIG. 4, a method 300 of forming the battery 100 is shown. Method 300 includes various steps (e.g., also referred to as blocks or operations) further discussed below. The method 300 includes a step 302 of forming the solid cathode material 10a. Step 302 may be the same as step 202 described above.

Next, the method 300 includes a step 304 of forming a battery (except for the catholyte 10b), such as the battery 100 described above. In step 304, the solid cathode material 10a is assembled with a cathode current collector 12, a separator 30, an anode 20, and an anode current collector 22. These components may be as described above. In some embodiments, in step 304, the battery 100 is not sealed or is only partially sealed to allow for injection of the catholyte 10b in step 306 described below.

In step 306 of the method 300, the catholyte 10b comprising lithium polysulfide is formed. Step 306 may be the same as step 204 described above. Step 306 may be performed simultaneously with step 302 or 304, before step 302, before step 304, between steps 302 and 304, or after step 304.

The method 300 further includes a step 308 of infiltrating pores of the solid cathode material 10a and the separator 30 with the catholyte 10b. The techniques for infiltrating the pores may be the same as those described with respect to step 206 above. In some embodiments, step 308 comprises injecting the catholyte 10b into a battery housing and then sealing the battery housing. In some embodiments, the battery 100 is a pouch cell battery and step 308 comprises injecting the catholyte 10b into the pouch and then sealing the pouch. In some embodiments, step 308 includes the catholyte 10b forming a passivation layer on the anode 20.

In some embodiments, the method 300 further includes a step 310 of operating the battery 100 by applying an external electrical load to discharge the battery 100. In some embodiments, the lithium polysulfide within pores of the solid cathode material 10a discharges at 1 to 3 V, 1.5 to 2.8 V, or 1.8 to 2.4 V.

### Example

Two CR2032 button cell batteries were assembled with a lithium foil anode, a Celgard® 2300 separator, and a CFₓ-CuPc cathode. In one battery (the CFₓ-CuPc battery), the electrolyte included 1 M LiFSI in DME but did not include lithium polysulfide. In the second battery (the hybrid cathode battery), the electrolyte (catholyte) included 1M LiFSI and 1 M Li₂S₈ in TG:DME (3:7 v/v). The batteries were each discharged at a rate of C/3 and the capacity for each was measured.

In particular, the CFₓ-CuPc battery generated a discharge capacity of 907 mAh/g of CFₓ-CuPc and an energy density of 1,609 mWh/g of CFₓ-CuPc. The hybrid cathode battery generated a discharge capacity of 1,661 mAh/g of CFₓ-CuPc and an energy density of 2,977 mWh/g of CFₓ-CuPc. These results represent a 1.8× increase in discharge capacity and a 1.9× increase in energy density due to the use of the lithium polysulfide catholyte.

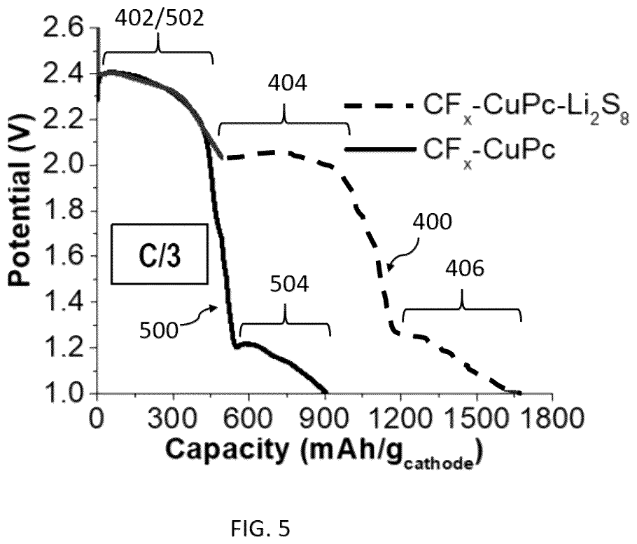

The results are further shown in FIG. 5, which includes a discharge profile 400 for the hybrid cathode battery and a discharge profile 500 for the CFₓ-CuPc battery. Each profile 400, 500 includes a first plateau 402, 502 of about equal size and shape between about 2.1 and 2.4 V. However, the profiles 400, 500 diverge at about 2.1 V where the profile 400 includes a second plateau 404 from about 1.9 to 2.1 V. The second plateau 404 is understood to be due to the presence of Li₂S₈ in the hybrid cathode battery. Finally, between 1.0 and about 1.2 V, the profile 500 has a second plateau 504 and the profile 400 has a third plateau 406. These final plateaus 406, 504 of the profiles 400, 500 are understood to be due at least in part to the presence of LiFSI in the electrolyte.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A hybrid cathode comprising:
a solid cathode material comprising an open pore structure and formed of a carbon monofluoride material and one or both of a phthalocyanine compound and a manganese oxide material; and
lithium polysulfide disposed within pores of the solid cathode material.

2. The cathode of claim 1, wherein:
the carbon monofluoride material is represented by the formula CFₓ, wherein x is in a range of about 0.5 to less than 1.2;
the phthalocyanine compound is represented by the formula MPc, wherein M is a metal;
the manganese oxide compound is represented by the formula MnO₂; and
the lithium polysulfide is represented by the formula Li₂S_{y} where y is in a range of 3 to 12.

3. The cathode of claim 2, wherein:
a molar ratio of CFₓ:MPc is 100:0 to 20:80;
a molar ratio of CFₓ:MnO₂ is 100:0 to 10:90; and
the lithium polysulfide is dissolved in an electrolyte.

4. The cathode of claim 2, wherein M is Cu, Fe, Co, Zn, Sn, Pb, Ni, Mg, Mn, Cd, Ag, FCr, Li₂, or VO.

5. The cathode of claim 1, wherein the solid cathode material has a porosity of at least 10%.

6. The cathode of claim 1, further comprising:
a conductive additive comprising carbon black, acetylene black, carbon nanotubes, and/or graphene; and
a polymer binder comprising a fluorinated alkane polymer, an alkane polymer, a hydroxyl-functionalized alkane polymer, an amide-functionalized alkane polymer, a nitrile-functionalized alkane polymer, an amine polymer, an aromatic-functionalized alkane polymer, an aromatic polymer, a saccharide polymer, a thiophene polymer, and/or a polyether polymer.

7. A battery comprising:
a cathode comprising a solid cathode material comprising an open pore structure and formed of a carbon monofluoride material and one or both of a phthalocyanine compound and a manganese oxide material;
a porous separator;
a lithium metal anode; and
a catholyte comprising lithium polysulfide, wherein the catholyte is disposed within pores of the solid cathode material and of the separator.

8. The battery of claim 7, wherein:
the carbon monofluoride material is represented by the formula CFₓ, wherein x is in a range of about 0.5 to less than 1.2;
the phthalocyanine compound is represented by the formula MPc, wherein M is a metal;
the manganese oxide material is represented by the formula MnO₂; and
the lithium polysulfide is represented by the formula Li₂S_{y} where y is in a range of 3 to 12.

9. The battery of claim 7, wherein the battery is a primary battery.

10. The battery of claim 8, wherein:
a molar ratio of CFₓ:MPc is 100:0 to 20:80;
a molar ratio of CFₓ:MnO₂ is 100:0 to 10:90; and
M is Cu, Fe, Co, Zn, Sn, Pb, Ni, Mg, Mn, Cd, Ag, FCr, Li₂, or VO.

11. The battery of claim 7, wherein the solid cathode material has a porosity of at least 10%.

12. The battery of claim 7, wherein the cathode further comprises:
a conductive additive comprising carbon black, acetylene black, carbon nanotubes, and/or graphene; and
a polymer binder comprising a fluorinated alkane polymer, an alkane polymer, a hydroxyl-functionalized alkane polymer, an amide-functionalized alkane polymer, a nitrile-functionalized alkane polymer, an amine polymer, an aromatic-functionalized alkane polymer, an aromatic polymer, a saccharide polymer, a thiophene polymer, and/or a polyether polymer.

13. The battery of claim 7, wherein the battery is a button battery, a cylindrical battery, a pouch battery, or a prismatic cell battery.

14. A method comprising:
assembling a solid cathode material and lithium metal anode with a porous separator therebetween, wherein the solid cathode material comprises an open pore structure and is formed of a carbon monofluoride material and one or both of a phthalocyanine compound and a manganese oxide material;
forming a catholyte comprising lithium polysulfide; and
infiltrating pores of the solid cathode material and the separator with the catholyte.

15. The method of claim 14, wherein:
the carbon monofluoride material is represented by the formula CFₓ, wherein x is in a range of about 0.5 to less than 1.2;
the phthalocyanine compound is represented by the formula MPc, wherein M is a metal;
the manganese oxide material is represented by the formula MnO₂; and
the method further comprises forming the solid cathode material by:
mixing CFₓ and one or both of MPc and MnO₂ with a conductive additive comprising carbon black, acetylene black, carbon nanotubes, and/or graphene, a polymer binder comprising a fluorinated alkane polymer, an alkane polymer, a hydroxyl-functionalized alkane polymer, an amide-functionalized alkane polymer, a nitrile-functionalized alkane polymer, an amine polymer, an aromatic-functionalized alkane polymer, an aromatic polymer, a saccharide polymer, a thiophene polymer, and/or a polyether polymer, and a solvent to form a slurry or paste,
depositing the slurry or paste on a foil current collector, and
evaporating the solvent.

16. The method of claim 14, wherein forming the catholyte comprises:
producing Li₂S_{y} by reacting a lithium polysulfide precursor under inert atmosphere;
using solvent extraction to isolate the Li₂S_{y}; and
mixing the Li₂S_{y} with an electrolyte.

17. The method of claim 14, wherein:
the lithium polysulfide is represented by the formula Li₂S_{y} where y is in a range of 3 to 12; and
the solid cathode material has a porosity of at least 10%.

18. The method of claim 14, further comprising forming a button battery, a cylindrical battery, a pouch battery, or a prismatic cell battery.

19. A battery formed by the method of claim 14.

20. A battery comprising the cathode of claim 1.
